(19) United States
(12) Patent Application Publication
(10) Pub. No.: US 2012/0297305 A1
(43) Pub. Date: Nov. 22, 2012

(54) PRESENTING OR SHARING STATE IN PRESENCE

(75) Inventors: Alexander Hehmeyer, Bellevue, WA (US); Kelly Rolin, Seattle, WA (US); Amit Gupta, Redmond, WA (US)

(73) Assignee: MICROSOFT CORPORATION, Redmond, WA (US)

(21) Appl. No.: 13/109,442

(22) Filed: May 17, 2011

(51) Int. Cl. G06F 3/01; G06F 15/16

(52) U.S. Cl. 715/733

(57) ABSTRACT

Presentation and/or sharing status related information about a user is provided through a presence channel to alert existing or potential participants in a communication session. When the user is in a display sharing environment, giving a presentation, or sharing a display screen with other users, his/her state is detected. A presence status display may then be provided to other users in communication with the user or attempting to establish a communication session with the user alerting them that the user has duplicated their display onto other screens or display devices or has shared their desktop with one or more other users. A number of heuristics may be employed to determine presenting or sharing state of the user such as detection of display sharing, active presentation applications, calendar entries, active communication applications, facial detection through image capture devices, and the like.

### BACKGROUND

Modern communication systems employ features and capabilities of computers, computer networks, and general purpose/specialized software to facilitate multimodal communications. For example, co-workers can initiate a video communication session from their respective desktops to collaborate on a project, exchange text messages, share data/applications, etc. without having to leave their offices or a need for specialized equipment.

Traditional display sharing environments include presentation environments, where a user may give a presentation to one or more other individuals by duplicating a program or application on the user's computing device display screen onto large projection screens. In other display sharing environments, a user may share the user's desktop with another user over a network connection, or the user may present directly from the user's computing device to multiple users who may directly view the user's display screen. In any of these example display sharing environments, a portion of or the entire display screen is typically duplicated and shared with the viewers, such that email notifications, chat windows, message windows, alerts and other similar applications are visible to the viewers. In some cases viewers of a presentation may view personal information from the presenter's computing device display during a presentation and the notifications, messages and alerts may interrupt the display sharing environment, interfering with and disrupting a demonstration or presentation.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing presentation or sharing status related information about a user through a presence channel to alert existing or potential participants in a communication session. A system according to embodiments may detect when the user is in a display sharing environment, giving a presentation, or sharing a display screen with other users. A presence status display may then be provided to other users in communication with the user or attempting to establish a communication session with the user alerting them that the user has duplicated their display onto other screens or display devices or has shared their desktop with one or more other users. A number of heuristics may be employed to determine presenting or sharing state of the user such as detection of display sharing, active presentation applications, calendar entries, active communication applications, facial detection through image capture devices, and the like. According to other embodiments, a user may be enabled to configure their system such that conversations in selected modalities are blocked when the user is in a presenting mode. A presence status display according to embodiments may include any immersive experience, where a user may not want to get interrupted. The result is a status display that is slightly less strong than “Do not disturb” which may block all conversations, but stronger than “Busy” which may allow incoming communications.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example of a presentation mode in a collaborative environment;

FIG. 2 illustrates an example of shared display mode in a collaborative environment;

FIG. 3 illustrates an example presence status display that may be presented in a collaborative environment;

FIG. 4 illustrates example components of a system for providing a presentation/sharing status through presence information;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing a presence status display for presentation or sharing state in a collaborative environment according to embodiments.

### DETAILED DESCRIPTION

As briefly described above, presentation or sharing status related information about a user may be provided through a presence channel to alert existing or potential participants in a communication session. A presence status display may provide specific information regarding whether a user's device is in a presenting mode, sharing a display with other users, or in other similar collaborative display modes and when future presentations and display sharing may be scheduled. When a user's device is in an active presenting mode, a presence status display may indicate (in addition to regular presence information such as “Busy”, “Out of Office”, etc.) that a particular user is actively sharing the user's display with one or more other users. Based on the status information provided in the presence status display, another user may determine an appropriate time and method of communication with the presenting user and may act accordingly. Presenting status display is just one representation according to embodiments. An auto response or even voice prompts prior to another person dialing/calling the user in the presenting state may be employed according to other embodiments. Thus, the presenting status may be used as a signal before initiating an audio/video call, where the initiator may not have been paying attention to visual signal or does not have capability to view presence.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing a compact control menu over an interactive touch interface and detecting user touch input for expanding the control menu and executing commands. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

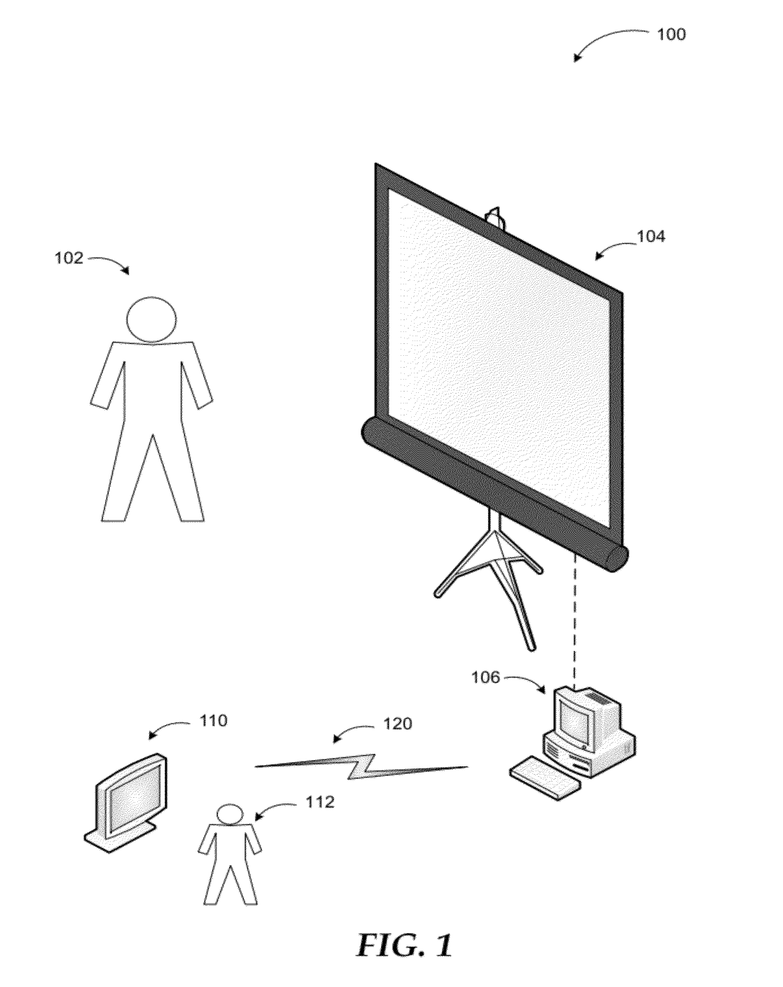

Referring to FIG. 1, diagram 100 illustrates an example of a presentation mode in a collaborative environment, where embodiments may be implemented. The computing device and user interface environment shown in diagram 100 are for illustration purposes. Embodiments may be implemented in various local, networked, and similar computing environments employing a variety of computing devices and systems. A collaborative environment may be a network of two or more computing devices, such as for example, a laptop computer, desktop computer, smart phone, tablet, or touch enabled device ('client devices') allowing users to interact with other users using the devices.

FIG. 1 illustrates an example embodiment of a configuration of a presentation mode environment, where a presenting user (the “publisher”) 102 may display information from the publisher's computing device 106 over a display screen 104. In a typical presentation mode environment 100, a publisher 102 may duplicate the display from the publisher's computing device 106 onto one or more screens or other display devices, such as a projection screen 104, in order to give a presentation to multiple users, for example. Generally, when the computing device's display is duplicated onto the display screen 104, a portion of or the entire display may be duplicated, including email notifications, chat windows, message windows, alerts and other similar applications, such that viewers of a presentation may view personal information from the presenter's computing device display during a presentation. The publisher may desire to alert other users that he/she is busy and unavailable during a presentation, so that the publisher does not receive communication requests, emails, and/or chats while the presentation is active. Additionally, a publisher may wish to deactivate communication windows and other alerts during a presentation. According to some embodiments, the user may not directly share a screen (desktop) or project onto a display, but actually present or share by remotely controlling some content. For example, the user may share a web link for a presentation and remotely control what is displayed on that web page.

In a system according to embodiments, a presence status display may be rendered in response to detection of a presentation mode. A presence status display may be provided over a network communication channel 120 on display screens 110 of multiple users 112 ability to display any kind of presence status. In other words, displayed presence information may directly show that the publisher's display is being shared, or the data may be abstracted away and a more generic statement such as “User is Presenting” (or even more generic like “User does not wish to be disturbed”) provided. In addition, other information may be derived from the presenting status such as “User is In a Meeting” or “User is located in the Office”, especially if the presenting status is combined with other presence information already available. A presenting user's active participation in a presentation mode such as the publisher's computing device 106 being duplicated onto a projection screen 104 may be displayed. The presence status display may contain specific information regarding whether the publisher's device is actively being used to deliver a presentation and other users 112 may use the status information provided on the presence status display to determine if and when a presenting user may be available for communication.

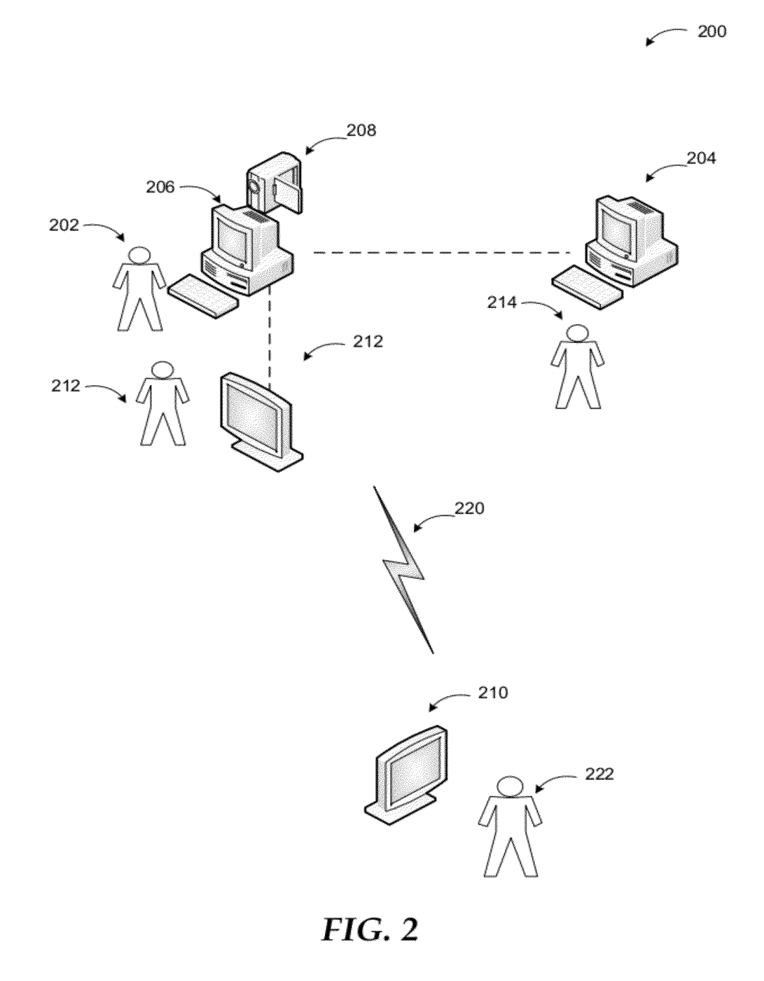

FIG. 2 illustrates an example of a shared display mode in a collaborative environment. Shared display modes may take many forms, and a system according to embodiments may employ a variety of different methods to detect shared display mode on the part of a publisher in a communication. For example, user 202's computing device 206 may be physically connected to a secondary display 212 potentially indicating that a second user 212 may be seeing the displayed content on secondary display 212. The secondary display may be a monitor, a projector, or similar display system. Computing device 206 may also be coupled to another computing device 204 over a wired and/or wireless network and user 202 may share desktop (or an application) with user 214 that enables user 214 to view a portion of the entire desktop of user 202 on his/her computing device 204. The display sharing may also be over a wireless connection (radio frequency waves, optical connection, etc.) such as the depicted connection between computing device 206 and display 210 allowing user 222 to view the desktop of user 202.

According to other embodiments, one or more other people may watch over the user's shoulder his/her display. This may be detected by employing a camera 208 attached to computing device 206 and performing facial detection, for example. In place of or in addition to image detection techniques, audio detection techniques using one or more microphones attached to the user's computing device (in this case the user acting as the publisher). Additional shared display detection methods may include detecting whether one or more sharing, presentation, and/or communication applications are active on the user's computing device. Furthermore, a physical location of the computing device (geospatial location and/or location relative to an infrastructure such as a building map) may also be employed to detect shared display or presentation mode for the publisher. For example, if the user is determined to be in a location such as a conference room, a convention center, an auditorium, a classroom or other public location where the user's display device may be viewable by multiple users, this may indicate shared display or presentation mode triggering the alert mechanism for other users that may be in an existing communication session or attempting to establish a communication session with the user.

In another example, the system may use calendar scheduling for determining whether a user is in a presentation or sharing mode. The system may determine based on scheduled events in a user's calendar as to when a sharing or presentation event is scheduled and update the presence status display during specific date and time blocks for one or more users. The presence status display may be updated to reflect which user is giving the presentation, and also, which users are also involved in sharing or viewing the presentation, based on schedule information recognized from a calendared event. Thus, a system according to embodiments may not only determine whether a user is in a shared display or presentation mode, but also who may be sharing the user's display or viewing his/her presentation.

The system may use the various methods and techniques for recognizing and detecting that a particular user is presenting or sharing the user's computing device display independently. The system may also utilize the methods and techniques concurrently, where the system uses two or more of the techniques to recognize a display sharing mode or to detect the presence of two or more users in order to determine that a user is in a sharing or presentation environment and to update a presence status display reflecting the presenting status of one or more users in the sharing environment. Using more than one detection method may allow the system to be more accurate in making a determination of a user's status in a sharing or presentation mode environment.

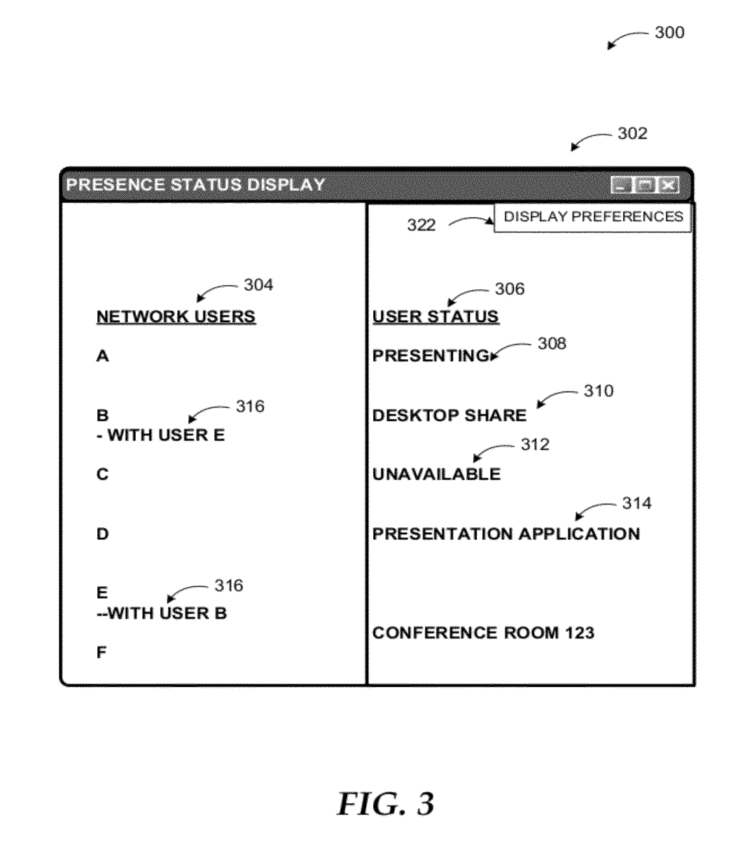

FIG. 3 illustrates an example presence status display that may be presented in a collaborative environment. The presence status display 302 shown in diagram 300 may provide specific information regarding a user's (publisher) availability or status of sharing or presenting to other users in a collaborative environment. The presence status display 302 may be provided over a network to any or all users within the collaborative environment through a presence channel, so that any user within the network may receive status information about other users within the network, and the presence status display 302 may be viewed on each individual user's computing device display. The presence status display 302 may be generated and continuously updated in order to provide status information about each of the users in the collaborative environment.

Presence status display rendering of the sharing/presenting state may employ text and/or graphics (e.g., icons) to display user status 306 indicating whether or not the publisher is in a shared display (310) or presenting state (308). User status 306 may further indicate whether the user is available or not (312). Presence status display 302 may also indicate an actual meeting in which the presentation is occurring, who the material is being presented to (i.e., which people are viewing), how many people are being presented to, and/or the environment in which the presentation is occurring (e.g., large auditorium, small conference room, private office, etc.). Presence status display 302 may further indicate the mechanism by which the presentation is occurring (e.g. projector, desktop sharing) and if any software is being used for the presentation (e.g., presentation application 314).

In some embodiments, presence status display 302 may indicate whether specialized presentation software or software not specifically designed for a presentation (e.g., web browser word processing application, etc.) are being used by the publisher. As mentioned previously, presence status display 302 may also indicate which users 316 may be sharing desktops or participating in a presentation among available users 304 for communication. This information may enable a user (also referred to a watcher herein) to determine whether privacy measures are warranted in a communication session with the publisher or not.

In another example embodiment, the system may also allow a user to specify user preference settings 322, where a user may override automatic detection and may inform the system of unavailability due to sharing or presentation modes, and additionally, a user may specify that certain users may be able to communicate, send emails, send instant messages, or certain alerts may be allowed during presentation or sharing modes. Further, a user may preset who can communicate with the user during sharing made and also what type of communication or alerts may be received during a sharing or presentation mode.

In a system according to embodiments, the presence status display 302 may be generated and continuously updated in order to provide specific information regarding the sharing or presentation status of a user in the network. In another embodiment, the presence status display 302 may be configured to display when future sharing modes may be scheduled and by and between which particular users within the network. Additionally, a user may customize the type of status information displayed on the presence status display 302 and the level of detail included in the presence status display according to each individual user's preferences and priorities. As discussed previously, the presenting status may also be used as a signal before initiating an audio/video call, where the initiator may not have been paying attention to visual signal or does not have capability to view presence.

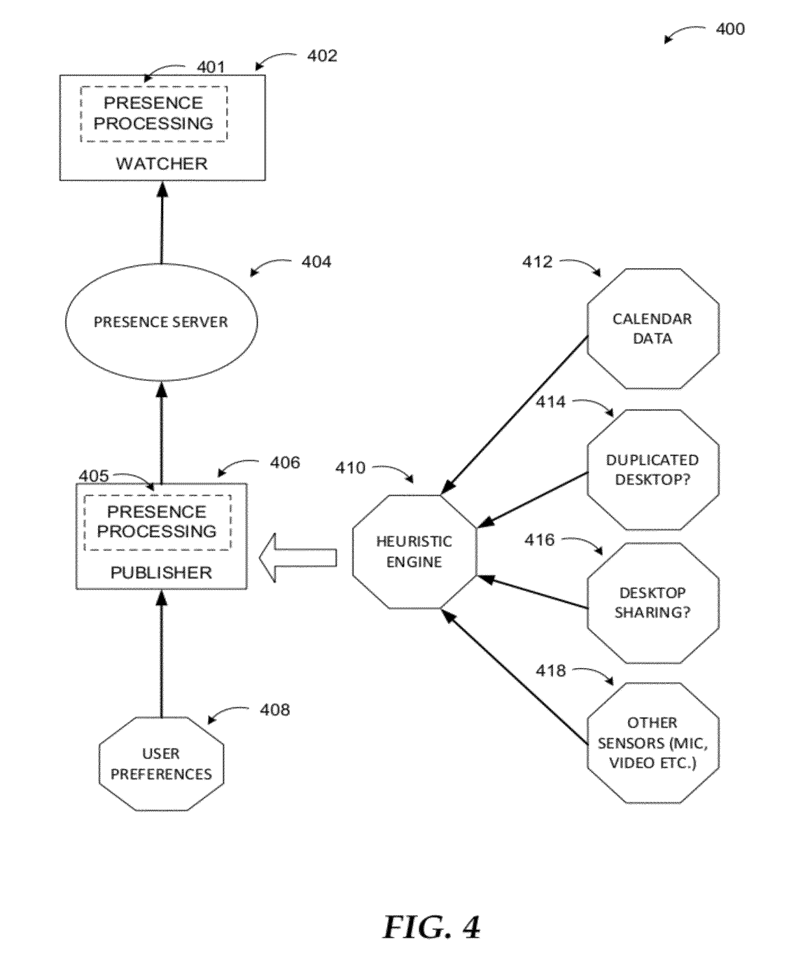

FIG. 4 illustrates example components of a system for providing a presentation/sharing status through presence information. In diagram 400, a number of example heuristics input mechanisms are shown for illustration purposes. These may include calendar data 412, desktop duplication detection 414, desktop sharing detection 416, other sensors 418 (such as microphones, video capture equipment, etc.) feeding into a heuristic engine 410.

Heuristic engine 410 may compute employing one or more algorithms whether or not publisher 406 is in a display sharing state or presenting to others. The results may be adjusted based on user preferences 408 and provided to a presence server 404, which may publish the state through a presence channel to other users (e.g., watcher 402). Watcher 402 may then determine whether they want to establish (or continue) a communication session with the publisher 406 and/or take proper privacy measures.

According to some embodiments, other information may be derived from or combined with the presenting status. For example, the system may determine based on one or more heuristics that the user (publisher) is presenting and is in a manager's private conference room. Thus, the published information may look like “Publisher is presenting to the Manager!” as the presence state. It should be noted, that this does not change the heuristic to detect whether the publisher is presenting (which could be based on the fact the publisher is in that special conference room—or not), but is based on combining different pieces of presence data to create a new outcome. The combination may be performed at different places. For example, presence processing module 405 at publisher 406 may transform what is published based on the combination or processing module 401 may transform what is actually displayed based on received presence information (different pieces of presence information).

The example systems in FIG. 1 through 4 have been described with specific devices, applications, and interactions. Embodiments are not limited to systems according to these example configurations. A system for detecting a sharing mode environment and providing a presence status display in a collaborative environment may be implemented in configurations employing fewer or additional components and performing other tasks. Furthermore, specific protocols and/or interfaces may be implemented in a similar manner using the principles described herein.

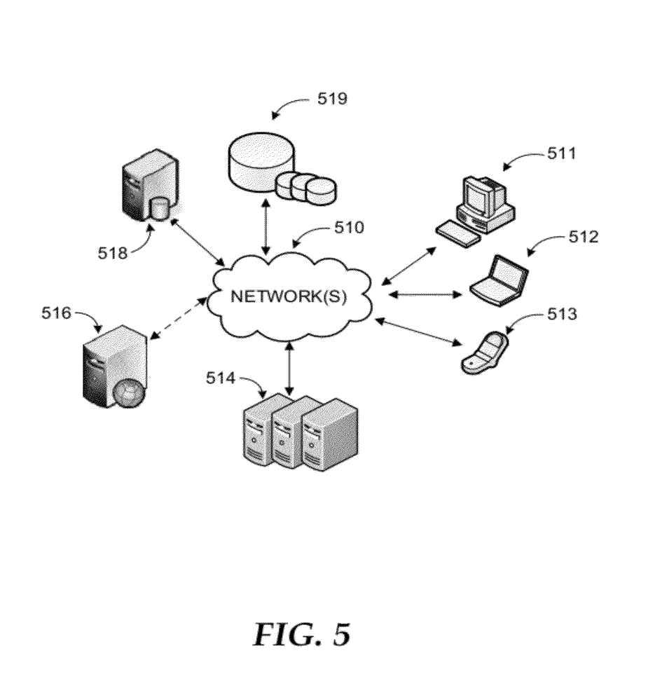

FIG. 5 is an example networked environment, where embodiments may be implemented. A system for detecting a sharing mode environment and providing a presence status display in a collaborative environment may be implemented via software executed over one or more servers 514 such as a hosted service. The platform may communicate with client applications on individual computing devices such as a smart phone 513, a laptop computer 512, or desktop computer 511 ('client devices') through network(s) 510.

Client applications executed on any of the client devices 511-513 may facilitate communications via application(s) executed by servers 514, or on individual server 516. An application executed on one of the servers may facilitate the detection of a sharing mode environment and providing a presence status display in a collaborative environment. The application may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform for detecting a sharing mode environment and providing a presence status display in a collaborative environment. Furthermore, the networked environments discussed in FIG. 5 are for illustration purposes only. Embodiments are not limited to the example applications, modules, or processes.

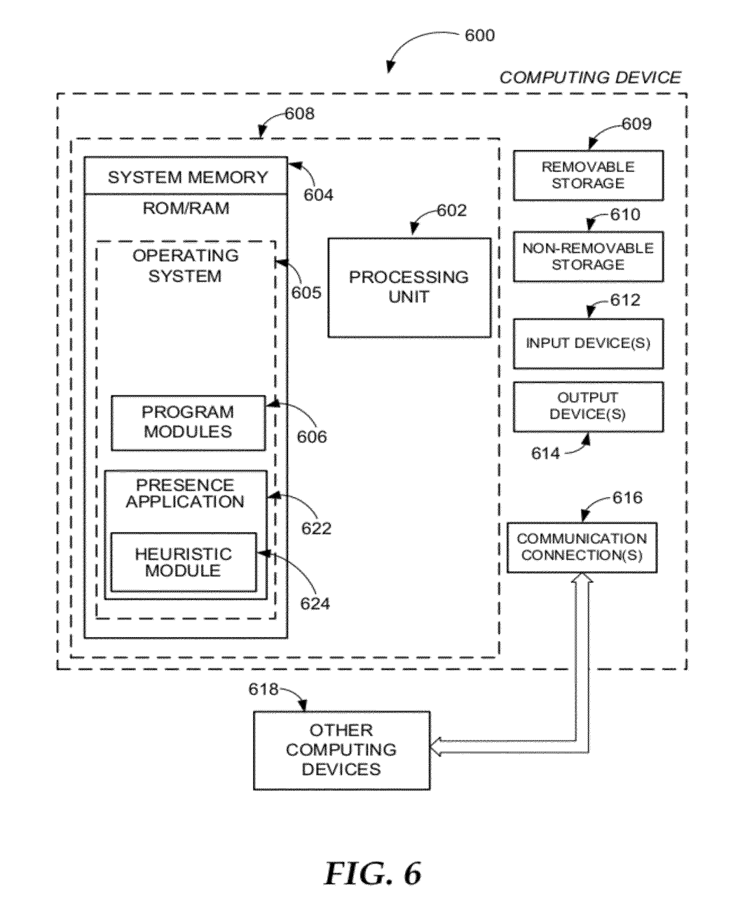

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing a presence based application according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, presence application 622, and heuristic module 624.

Heuristic module 624 may enable a computing device 600 to continually detect a sharing mode environment and/or a presentation mode environment, based on the variety of factors and detection mechanisms. Through the heuristic module 624, presence application 622 may publish display sharing and/or presentation state of a user along with the user's presence status to other users within a collaborative network environment. Presence application 622 and heuristic module 624 may be separate applications or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

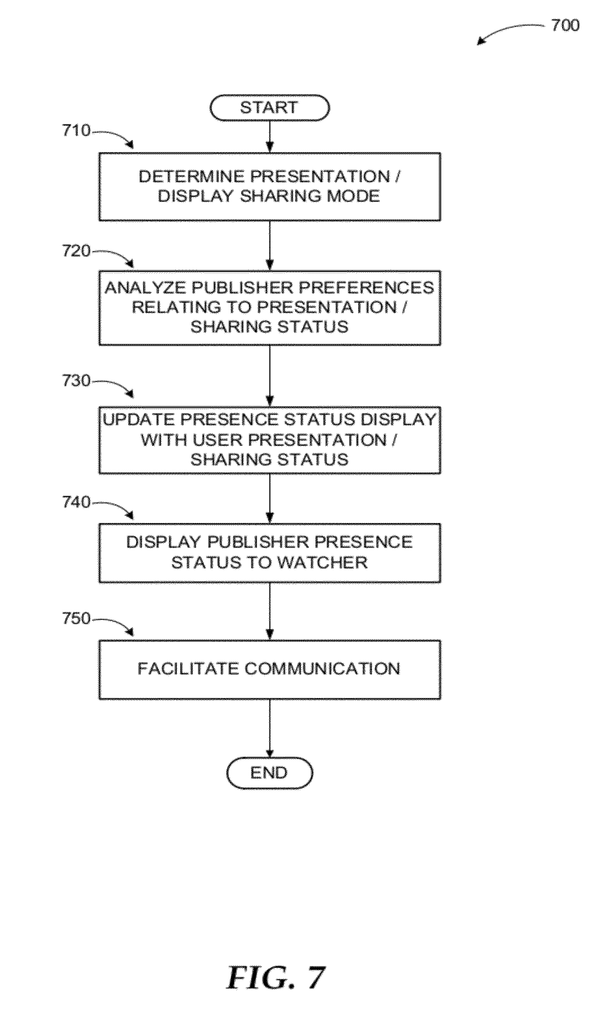

FIG. 7 illustrates a logic flow diagram for a process 700 of providing a presence status display for presentation or sharing state in a collaborative environment according to embodiments. Process 700 may be implemented on a client device communicating with a presence server or a server coupled to a client device.

Process 700 begins with operation 710, where the system determines whether a user (“publisher”) is in a display sharing and/or presentation mode based on detection of desktop sharing software, display connections, calendar data, and comparable methods. Whether the user is in a presentation mode may also be determined based on detecting a type of computing device employed by the user. For example, the user may sign on to a room system device for conference or meeting sessions such as a smart board or a computer connected to a projector only and use it for presenting. In such cases, the system may detect activity through the room system and not necessarily based on a sharing application or secondary display on the user's machine.

At operation 720, publisher preferences relating to the presentation/display sharing status may be analyzed to determine what information is to be published to other users and if any of the status information needs to be overridden. This may be followed by operation 730, where a presence status display presented to other users based on the publisher's presence information is updated. The presence status display may include publisher's presentation/display sharing state.

At operation 740, the publisher's presentation/display sharing information is presented to other users (“watchers”) through the presence status display such that they can determine whether or not to continue/initiate a communication session with the publisher or take proper privacy measures. If a watcher decides to initiate or continue an existing communication session, the session may be facilitated at operation 750.

The operations included in process 700 are for illustration purposes. Sharing and presentation environment detection and providing a presence status display may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method at least partially executed on a computing device for providing a presenting and/or display sharing state through a presence channel, the method comprising:
determining whether a user is in at least one of a presenting mode and a display sharing mode;
incorporating the at least one of the presenting mode and the display sharing mode in a presence status of the user; and
publishing the user's presence status to at least one other user.

2. The method of claim 1, further comprising:
analyzing one or more preferences of the user; and
modifying at least a portion of the published presence status based on the one or more preferences of the user.

3. The method of claim 1, further comprising:
determining whether the user is in a display sharing mode based on detecting duplication of the user's display interface onto one or more displays.

4. The method of claim 1, further comprising:
determining whether the user is in a display sharing mode based on detecting duplication of the user's display onto a second user's display via a desktop sharing application.

5. The method of claim 1, further comprising:
determining whether the user is in a display sharing mode based on one of a visual detection of two or more people in proximity of the user's display and an audio detection of two or more people in proximity of the user's display.

6. The method of claim 1, further comprising:
determining whether the user is in a presentation mode based on detecting one of a location of the user's computing device and a type of computing device used by the user.

7. The method of claim 1, further comprising:
determining whether the user is in a presentation mode based on detecting an active application designed for presentations on the user's computing device.

8. The method of claim 1, further comprising:
determining whether the user is in at least one of a presenting mode and a display sharing mode based on data from a calendar application associated with the user.

9. The method of claim 1, further comprising:
enabling at least one from a set of: disabling message displays, pop-up menus, request displays, and alert displays while the user is operating in one of the display sharing mode and the presentation mode; and
providing one of an audio signal and a voice prompt alerting a caller attempting to establish one of an audio and a video communication session while the user is operating in one of the display sharing mode and the presentation mode.

10. The method of claim 1, wherein the published presence status includes at least one from a set of: a type of display sharing mode, a location of the user, availability of the first user, one or more users involved in the display sharing mode, and a type of application facilitating one of the display sharing mode and the presentation mode.

11. The method of claim 10, wherein published presence status information is customizable based on user preferences for level of detail to be included in presenting the presence status to other users.

12. A computing device for providing a presenting and/or display sharing state through a presence channel, the computing device comprising:
a memory;
a processor coupled to the memory, the processor executing an application generating a presence status display that includes presenting and/or display sharing state information, wherein the application is configured to:
determine whether a user is in at least one of a presenting mode and a display sharing mode;
update a presence status of the user with the presenting and/or display sharing state;
publish the user's presence status to at least one other user;
enable rendering of the presence status display on a computing device associated with the at least one other user displaying presenting and/or display sharing state information for the user.

13. The computing device of claim 12, wherein the application is further configured to:
determine whether the user is in a display sharing mode based on at least one from a set of: detecting duplication of the user's display interface onto one or more displays; detecting duplication of the user's display onto a second user's display via a desktop sharing application; a visual detection of two or more people in proximity of the user's display; and an audio detection of two or more people in proximity of the user's display.

14. The computing device of claim 12, wherein the application is further configured to:
determine whether the user is in a presentation mode based on detecting a location of the user's computing device; detecting an active application designed for presentations on the user's computing device; and data from a calendar application associated with the user.

15. The computing device of claim 14, wherein the application is further configured to determine whether the active application designed for presentations is in a presentation mode.

16. The computing device of claim 14, wherein the location of the user's computing device includes one of a geospatial location and a location relative to an infrastructure.

17. The computing device of claim 12, wherein the application is further configured to:
determine whether the user is in a presentation mode based on detecting an active communication application on the user's computing device.

18. The computing device of claim 12, wherein the presence status display is configured to display an availability status of the user, a type of display sharing mode for the user, a location of the user in display sharing mode, a mechanism used for the display sharing mode, one or more users involved in display sharing, and a type of application facilitating the display sharing mode.

19. A computer-readable storage device with instructions stored thereon for providing a presenting and/or display sharing state through a presence channel, the instructions comprising:
determining whether a user is in a display sharing mode based on at least one from a set of: detecting duplication of the user's display interface onto one or more displays; detecting duplication of the user's display onto a second user's display via a desktop sharing application; a visual detection of two or more people in proximity of the user's display; and an audio detection of two or more people in proximity of the user's display;
determining whether the user is in a presentation mode based on detecting a location of the user's computing device; detecting an active application designed for presentations on the user's computing device; and data from a calendar application associated with the user;
updating a presence status of the user with the presenting and/or display sharing state; and
publishing the user's presence status to at least one other user.

20. The computer-readable storage device of claim 19, wherein the instructions further comprise:
continuously providing presence status updates that include presenting and/or display sharing state of the user through a presence channel.
